(19) United States
(12) Patent Application Publication
(10) Pub. No.: US 2014/0160543 A1
(43) Pub. Date: Jun. 12, 2014

(54) HOLOGRAPHIC IMAGING OPTICAL DEVICE

(71) Applicant: SAMSUNG ELECTRONICS CO., LTD., Suwon (KR)

(72) Inventors: Andrey Nikolaevich Putilin, Moscow (RU); Vladislav Vladimirovich Druzhin, Moscow (RU); Elena Gennadievna Malinovskaya, Moscow (RU); Alexander Victorovich Morozov, Moscow (RU); Ivan Vladimirovich Bovsunovsky, Zhukov (RU)

(73) Assignee: SAMSUNG ELECTRONICS CO., LTD., Suwon (KR)

(21) Appl. No.: 14/100,567

(22) Filed: Dec. 9, 2013

(30) Foreign Application Priority Data
Dec. 10, 2012 (RU) 2012153138
Sep. 27, 2013 (KR) 10-2013-0115491

(51) Int. Cl. G03H 1/22; G02B 27/01

(52) U.S. Cl. CPC G03H 1/2205; G03H 1/2294; G02B 27/0103
USPC 359/9

(57) ABSTRACT

In relation to a field of creating and processing a digital image, a compact portable device for generation and observation of dynamic and static holograms is provided. A system including a holographic display may be based on reconstruction and transmission of a wavefront encoded with a spatial light modulator while preserving information about a wave amplitude and a phase. Due to such features of the holographic process, an optical device may restore a wavefront similar to a wavefront coming from real objects.

### CROSS-REFERENCE TO RELATED APPLICATION

This application claims the priority benefit of Russian Patent Application No. 2012153138 filed on Dec. 10, 2012, in the Russian Patent Office, and Korean Patent Application No. 10-2013-0115491 filed on Sep. 27, 2013, in the Korean Intellectual Property Office, the disclosure of which is incorporated herein by reference.

### BACKGROUND

1. Field

One or more example embodiments of the following description relate to a field of generating and processing a digital image, and more particularly, to a compact portable device for generation and observation of dynamic and static holograms.

2. Description of the Related Art

Various designs of portable devices have been developed, which are capable of generating and displaying dynamic and static 3-dimensional (3D) holographic images formed by a spatial light modulator, illuminated with a reference beam of coherent radiation and synthesized by a computer. In this case, light waves are diffracted by a periodical structure of a spatial light modulator, thus enabling reconstruction of a wavefront which includes information about a 3D image. Those devices are used for generation of digital images presented as holograms on a spatial light modulator and for observation of holographic images reconstructed by means of an optical system. Such an optical system includes holographic and diffractive elements including semi-transparent elements. The reconstructed holographic images are combined with real objects in a field of view of the device. An important feature of the devices is in compactness of the optical system of the device and applicability of a planar arrangement of the device.

### SUMMARY

The foregoing and/or other aspects may be achieved by providing an optical device including a micro-display which provides spatial distribution of light in an object plane, and an optical light guiding plate mounted to a holographic optical element transferring an image via a light guiding plate to an observer eye.

According to embodiments, a system including a holographic display is based on reconstruction and transmission of a wavefront encoded with a spatial light modulator while preserving information about a wave amplitude and a phase. Due to these features of the holographic process, the optical device may be capable of restoring a wavefront similar to a wavefront coming from real objects. Therefore, a 3-dimensional (3D) scene may be created with a particular feature of eye accommodation with respect to different points of an image plane while merging eye accommodation and convergence planes.

According to embodiments, the optical device may apply a method of reconstructing a 3D image of an object synthesized by software and hardware. The image needs to correspond to observation of an actual 3D object when observed by eyes.

The optical device that generates and displays a holographic dynamic and static 3D image, the optical device may include a laser source of coherent radiation, a light guiding plate, a holographic optical element fixed to a surface of the light guiding plate, a spatial light modulator to generate a digital hologram, and at least one electronic unit comprising an interface unit and a control circuit for the spatial light modulator. The holographic optical element may be arranged along a radiation path from the laser source such that the spatial light modulator is disposed on the light guiding plate after the holographic optical element redirects the radiation into the light guiding plate and before the holographic optical element redirects the radiation outward from the light guiding plate.

The light guiding plate may include arbitrary curved surfaces by which the radiation is distributed through total internal reflection.

The spatial light modulator may perform space-time transformation of a beam along with output of a computer-generated hologram reconstructing a 3D image at output of the optical device.

The holographic optical element may input the radiation from the laser source into the light guiding plate, and transform and redirect wavefront propagation into the light guiding plate.

The spatial light modulator may generate a holographic image based on diffraction and interference on a modulator discrete structure that subsequently overlaps the holographic image with real objects within a field of view of the optical device.

The light guiding plate may be made of an optical transparent material having a is refractive index higher than a refractive index of an external media and may transmit the radiation through the total internal reflection.

The electronic unit including the interface unit and the control circuit of the spatial light modulator and the interface unit may provide an external source to the interface of the optical device and enable output of a computer-generated hologram.

The at least one holographic optical element may enable output of radiation from the light guiding plate and generate a hologram visible by a naked eye at the output of the optical device.

The holographic optical element may be a transmission type holographic optical element appearing on a first surface of the light guiding plate with respect to the observer eye.

The at least one transmission type holographic optical element may be mounted to the first surface of the light guiding plate and enable output of radiation from the light guiding plate.

The holographic optical element may be a reflection type holographic optical element appearing on a second surface of the light guiding plate with respect to the observer eye.

The at least one reflection type holographic optical element may be mounted to the second surface of the light guiding plate and enable output of radiation from the light guiding plate.

The spatial light modulator may be a transmission type spatial light modulator accommodated in a glass plate surface.

The transmission type spatial light modulator may be disposed between the light guide and a plane-parallel plate on the second surface of the light guiding plate with respect to the observer eye.

The transmission type spatial light modulator may be disposed between the light guide and a plane-parallel plate on the first surface of the light guiding plate with respect to the observer eye.

The transmission type spatial light modulator may be disposed between the light guiding plate and the first surface of the light guiding plate with respect to the observer eye, together with a transmission type holographic optical element that changes a shape and direction of a beam after passing through the spatial light modulator.

The transmission type spatial light modulator may be disposed between the light guide and a plane-parallel plate formed on the second surface of the light guide with respect to the observer eye, together with a transmission type holographic optical element that changes a shape and direction of a beam after passing through the spatial light modulator.

The transmission type spatial light modulator may be disposed on the second surface of the light guiding plate with respect to the observer eye between two transmission type holographic optical elements that change a shape and direction of a beam before and after passing through the transmission type spatial light modulator.

The transmission type spatial light modulator may be disposed on the first surface of the light guiding plate with respect to the observer eye between two transmission type holographic optical elements that change a shape and direction of a beam before and after passing through the transmission type spatial light modulator.

The transmission type spatial light modulator may be disposed on the first surface of the light guiding plate with respect to the observer eye between the light guiding plate and the transmission type holographic optical element that changes a shape and direction of a beam before passing through the transmission type spatial light modulator.

The transmission type spatial light modulator may be disposed on the second surface of the light guiding plate with respect to the observer eye between the light guiding plate and the transmission type holographic optical element that changes a shape and direction of a beam before passing through the transmission type spatial light modulator.

The spatial light modulator may be a reflection type spatial light modulator.

The reflection type spatial light modulator may be disposed on the first surface of the light guiding plate with respect to the observer eye.

The reflection type spatial light modulator may be disposed on the second surface of the light guiding plate with respect to the observer eye.

The reflection type spatial light modulator may be disposed on the first surface of the light guiding plate with respect to the observer eye, together with the transmission type holographic optical element that changes a shape and direction of a beam after being reflected by the reflection type spatial light modulator.

The reflection type spatial light modulator may be disposed on the second surface of the light guiding plate with respect to the observer eye, together with the transmission type holographic optical element that changes a shape and direction of the wavefront after being reflected by the reflection type spatial light modulator.

The reflection type spatial light modulator may be disposed at an end of the light guiding plate.

The laser source disposed near an eye may illuminate at least one reflection type holographic optical element disposed on the second surface of the light guiding plate, input the radiation into the light guiding plate, redirect the wavefront propagation, and transform the beam shape. According to example embodiments, the wavefront propagation may be light wave propagation.

The laser source disposed on the second surface of the light guiding plate the eye may illuminate at least one reflection type holographic optical element disposed on the first surface of the light guiding plate, input the radiation into the light guiding plate, redirect the wavefront propagation, and transform the beam shape.

The laser source disposed at an eye side may illuminate at least one transmission type holographic optical element disposed on the first surface of the light guiding plate, input the radiation into the light guiding plate, redirect the wavefront propagation, and transform the beam shape.

The laser source disposed at an external side may illuminate at least one transmission type holographic optical element disposed on the second surface of the light guiding plate, input the radiation into the light guiding plate, redirect the wavefront propagation, and transform the beam shape.

The optical device may further include a beam expander that transforms the radiation before the radiation enters the light guiding plate.

The holographic optical element may be at least one holographic optical element disposed on a surface of the light guiding plate, and configured to direct the radiation into the light guiding plate, transform a beam shape, generate a wavefront ensuring uniform illumination of the spatial light modulator, and reconstruct a hologram from the spatial light modulator.

The foregoing and/or other aspects may be achieved by providing an optical device based on use of an improved optical system which includes a spatial light modulator capable of generating a holographic image and a holographic and diffractive element.

This is achieved by a hologram capable of reconstructing an actual wavefront. Observation may not conflict with natural observation of real objects.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a holographic imaging optical device including a holographic and diffractive optical element based on a reflection type spatial light modulator, according to example embodiments;

FIG. 2 illustrates a holographic imaging optical device including a holographic and diffractive optical element based on a transmission type spatial light modulator, according to example embodiments;

FIGS. 3A to 3D illustrate an optical system for illumination of a spatial light modulator according to example embodiments;

FIGS. 4A to 4D illustrate an optical system for illumination of a spatial light modulator according to other example embodiments;

FIGS. 5A to 5D illustrate an optical system for illumination of a spatial light modulator according to still other example embodiments;

FIGS. 6A to 6D illustrate a position of a reflection type spatial light modulator on a light guiding plate, according to example embodiments;

FIGS. 7A to 7C illustrate a position of a transmission type spatial light modulator on a light guiding plate, according to example embodiments; and

FIGS. 8A to 8B illustrate a viewing part according to a position of a holographic optical element on a light guiding plate, according to example embodiments.

### DETAILED DESCRIPTION

Reference will now be made in detail to example embodiments, examples of which are illustrated in the accompanying drawings, wherein like reference numerals refer to the like elements throughout.

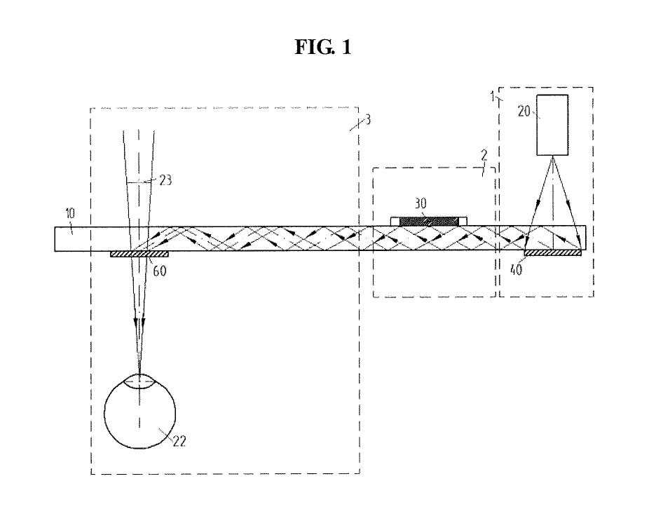

FIG. 1 illustrates a holographic imaging optical device with a holographic and diffractive optical element based on a reflection type spatial light modulator, according to example embodiments.

Referring to FIG. 1, the holographic imaging optical device may include an illumination system unit 1, a spatial light modulator unit 2, and a viewing part unit 3 for observation of a hologram through an eye 22. The optical device according to the example embodiments may be a device including a holographic and diffractive optical element for generation of a holographic image. The optical device may include at least one laser source 20 of coherent radiation, at least one reflection type spatial light modulator 30, and at least one light guiding plate 10 accommodating a holographic optical element 40 and a holographic optical element. Here, the holographic optical device may implement an optically transparent material with a higher refractive index than a surrounding medium for transmitting optical radiation through the light guiding plate, based on the phenomenon of total internal reflection. The illumination system unit 1 may include the light guiding plate 10 including a reflection type holographic optical element 40 that provides input of radiation coming from the laser source 20 to the light guiding plate 10, and transforms and redirects a wavefront inside the light guiding plate 10 for uniform illumination, for an optimal wavefront for illumination of the spatial light modulator 30, and for a hologram reconstruction. The spatial light modulator unit 2 may include a light guiding plate 10 and a spatial light modulator 30. The spatial light modulator 30 may shape a hologram through controlled spatial temporal modulation of a wavefront being introduced and diffraction and interference with respect to a modulator discrete structure. The control may be provided by an electronic device capable of controlling the spatial light modulator 30 and an interface unit that couples an optical device with external sources of information. The control may provide output of a computer generated hologram that reconstructs a 3D image at output of the optical device. The viewing part unit 3 may include a light guiding plate 10, and at least one transmission type holographic optical element 60 accommodated in the light guiding plate 10. The at least one transmission type holographic optical element 60 may redirect a light wave, transform a beam shape, output radiation from the light guide plate 10 while violating total internal reflection in the interface of the light guiding plate 10, and direct the radiation toward the eye 22. The optical system may generate a 3D image having an image viewing angle 23 and a subsequent overlap of the holographic image of real objects within an observation field of view of the optical system.

The optical device according to the example embodiments may generate and display dynamic and static 3D images of a holographic type. Such an optical device may include a laser source 20 of coherent radiation, a light guiding plate 10, a holographic optical device fixed to a surface of the light guiding plate, a spatial light modulator 30 adapted to generate a digital hologram, and at least one electronic unit which includes an interface unit and a control circuit for the spatial light modulator 30. The holographic optical element may be arranged along a radiation path from the laser source 20 in such a manner that the spatial light modulator 30 is disposed on the light guiding plate 10 after the holographic optical element redirects the radiation into the light guiding plate and before the holographic optical element redirects the radiation outward from the light guiding plate 10.

According to example embodiments, the light guiding plate 10 may be a plate having a predetermined curved surface on which the radiation is scattered through the principle of total internal reflection. According to other example embodiments, the light guiding plate 10 may be an optical medium in the form of a plate with a parallel or curved surface.

According to example embodiments, the spatial light modulator 30 may perform space-time transformation of a beam along with output of a computer-generated hologram reconstructing the 3D image at the output of the device.

According to example embodiments, the holographic optical element may input the radiation from the laser source 20 into the light guiding plate 10, and transform and redirect wavefront propagation into the light guiding plate 10. According to other example embodiments, the holographic optical element may be used to input radiation from a coherent light source into the light guiding plate 10. Also, the holographic optical element may be used for wavefront transformation and propagation within the light guiding plate 10 optimal for uniform illumination, and generation of the wavefront type optimal for illumination of the spatial light modulator 30 and reconstruction of a hologram thereon.

According to example embodiments, the spatial light modulator 30 may generate a holographic image by space-time modulation of the wavefront, based on diffraction and interference in a modulator discrete structure that sequentially overlaps the image with the real object within the observation field of view of the system. According to other example embodiments, the holographic image may be generated by the optical device 30 of the wavefront, based on diffraction and interference in the modulator discrete structure that sequentially overlaps the image with the real object within the observation field of view of the system.

According to example embodiments, the light guiding plate 10 may transmit the radiation through total internal reflection, and may be made of an optical transparent material having a refractive index higher than that of the environment.

The electronic unit including the interface unit and the control circuit for the spatial light modulator 30 may provide an external source to the interface of the optical device, and enable output of a computer generated hologram. According to other embodiments, an electronic control unit of the spatial light modulator 30 and of the interface unit may couple the optical device with external sources of information, and output the computer-generated holograms calculated on the basis of a 3D image resulting from mathematical transformation in a space-time domain.

The holographic optical element may operate as a spatial refractive beam hologram mounted to a surface of the light guiding plate 10, the surface nearest to the eye 22, that is, a first surface.

The holographic optical element may be implemented as a spatial refractive beam hologram mounted to a second surface of a light guiding plate 10 with respect to the eye 22.

The at least one holographic optical element may enable output of radiation from the light guiding plate 10 and generate a hologram visible by a naked eye at the output of the optical device.

The spatial light modulator 30 may be a reflection type spatial light modulator disposed on the first surface of the light guiding plate 10 with respect to the eye 22.

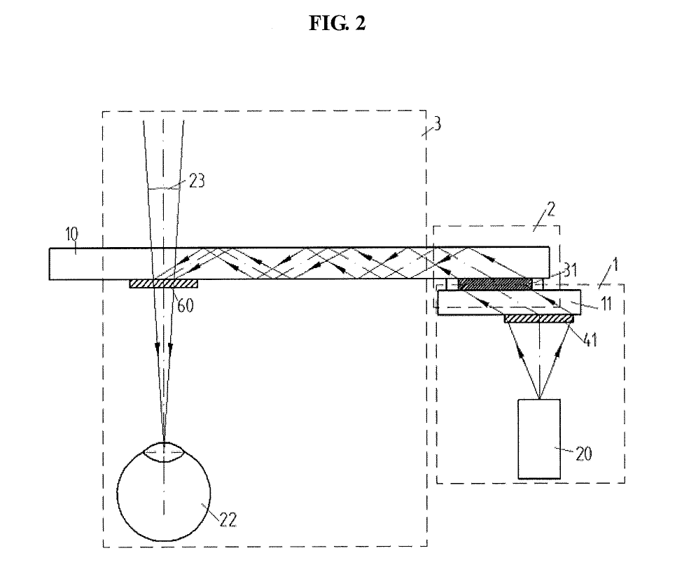

FIG. 2 illustrates a holographic imaging optical device including a holographic and diffractive optical element based on a transmission type spatial light modulator, according to example embodiments.

Referring to FIG. 2, a spatial light modulator according to other example embodiments, for example, a transmission type spatial light modulator 31 may be disposed between the light guiding plate 10 and a glass plate 11. In such a case, the glass plate 11 may accommodate a transmission holographic optical element 41 for input of radiation into the light guiding plate 10 and the transmission type spatial light modulator 31.

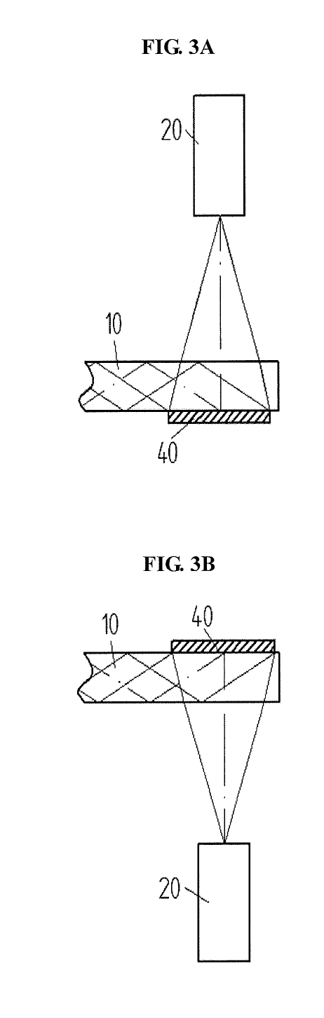

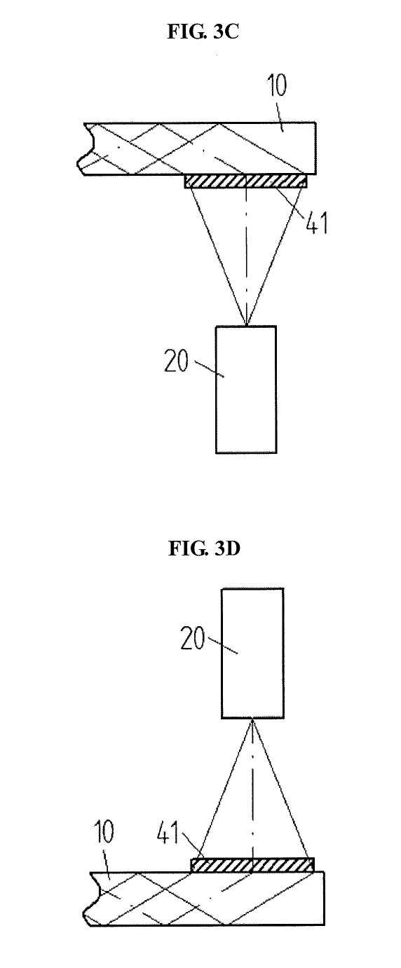

FIGS. 3A to 3D illustrate an optical system for illumination of a spatial light modulator according to example embodiments.

Referring to FIGS. 3A to 3D, the optical system for illuminating the spatial light modulator may be implemented in several variants. According to one example variant shown in FIG. 3A, a reflection type holographic optical element 40 is disposed on a first surface of the light guiding plate 10, the first surface with respect to an observer eye. The laser source 20 of coherent radiation is disposed at an opposite side to the reflection type holographic optical element 40 and adapted to illuminate the holographic optical element 40 through the light guiding plate 10. Here, the light guiding plate 10 may be an optical fiber. FIG. 3B illustrates transformation of the reflection type holographic optical element 40 mounted to a second surface of the light guiding plate 10 with respect to the observer eye. Referring to FIGS. 3C and 3D, a transmission type holographic optical element 41 may be used as a variant disposed on the first surface and the second surface of the light guiding plate 10 with respect to the observer eye.

According to the example shown in FIG. 3A, a laser source 20 disposed on the second surface of the light guiding plate 10 may illuminate at least one reflection type holographic optical element 40 disposed on the first surface of the light guiding plate 10, input radiation into the light guiding plate 10, redirect wavefront propagation, and transform a beam shape.

According to the example shown in FIG. 3B, a laser source 20 disposed near the eye side, for example the first surface of the light guiding plate 10, may illuminate at least one reflection type holographic optical element 40 disposed on the second surface of the light guiding plate 10 with respect to the observer eye, input the radiation into the light guiding plate 10, redirect the light wave propagation, and transform the beam shape.

According to the example shown in FIG. 3C, a laser source 20 disposed at a side of the eye may illuminate at least one transmission type holographic optical element 41 disposed on the first surface of the light guiding plate 10, input the radiation into the light guiding plate 10, redirect the light wave propagation, and transform the beam shape.

According to the example shown in FIG. 3D, a laser source 20 disposed at an external side of the eye may illuminate at least one transmission type holographic optical element 41 disposed on the second surface of the light guiding plate 10, input the radiation into the light guiding plate 10, redirect the light wave propagation, and transform the beam shape.

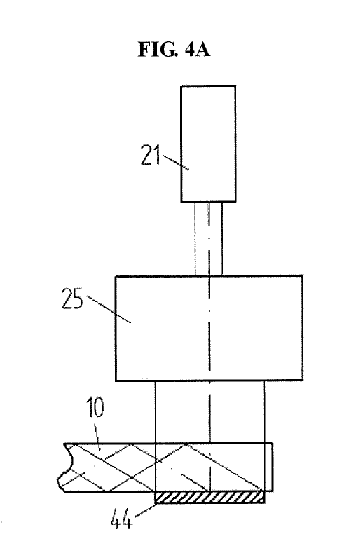

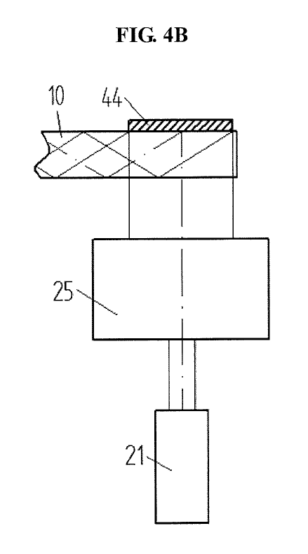

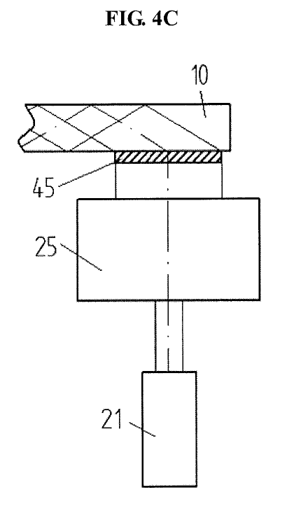

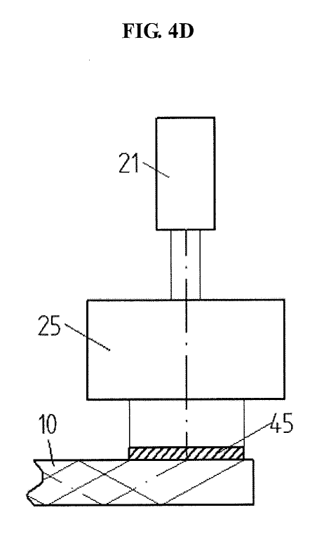

FIGS. 4A to 4D illustrate an optical system for illumination of a spatial light modulator according to other example embodiments.

According to other example embodiments shown in FIGS. 4A to 4D, a beam expander may be used in an afocal optical system to increase a beam diameter at an entry of the light guiding plate 10. FIGS. 4A and 4B illustrate a reflection type holographic optical element 44 in which a laser source 21 and a beam expander 25 are disposed at one side of the light guiding plate 10. FIGS. 4C and 4D illustrate a configuration of a transmission type holographic element 45 in which the laser source 21 and the beam expander 25 are disposed at one side of the light guide 10.

According to example embodiments, the optical device may further include a beam expander that transforms the radiation before the ration enters the light guiding plate 10.

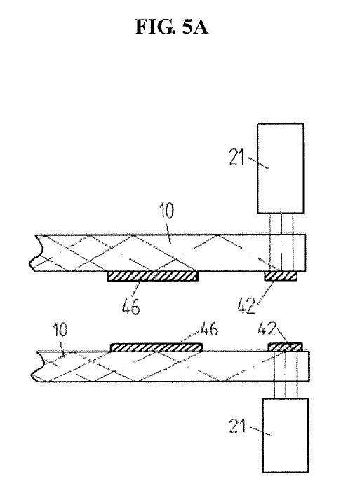

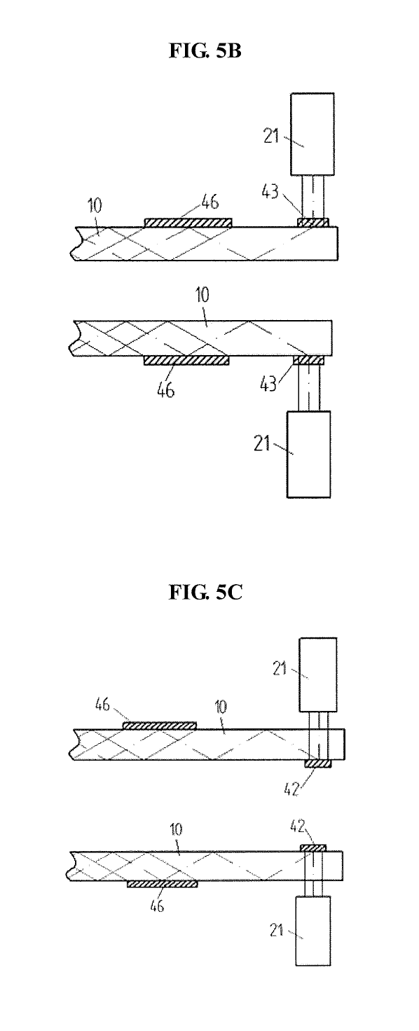

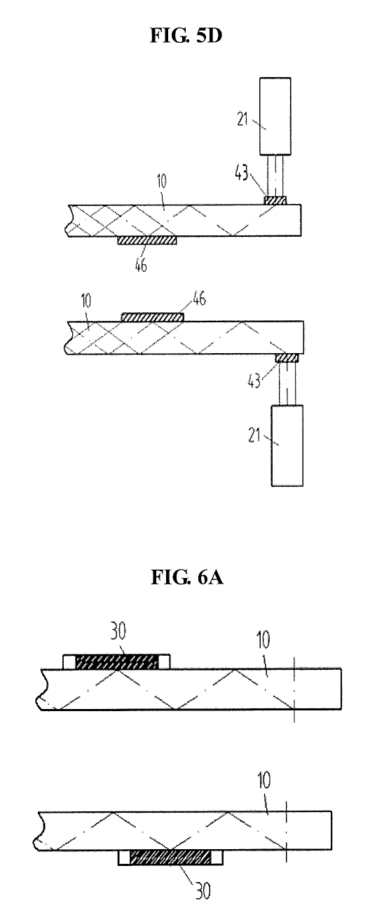

FIGS. 5A to 5D illustrate an optical system for illumination of a spatial light modulator according to still other example embodiments.

According to still other example embodiments shown in FIG. 5A, the optical system for illumination of a spatial light modulator may include a light guiding plate 10, and reflection type holographic optical elements 42 and 46 disposed at one side of the light guiding plate 10 to expand a beam size beam. According to a second variant of the system as shown in FIG. 5B, the optical system for illumination of a spatial light modulator may include a light guiding plate 10, and a transmission type holographic optical element 43 and a reflection type holographic optical element 46 disposed at one side of the light guiding plate 10 to expand a beam size. According to a third variant of the system as shown in FIG. 5C, the optical system for illumination of a spatial light modulator may include a light guiding plate 10, and reflection type holographic optical elements 42 and 46 disposed at opposite sides of the light guiding plate 10 to expand a beam size. According to a fourth variant of the system as shown in FIG. 5D, the optical system for illumination of a spatial light modulator may include a light guiding plate 10, and a reflection type holographic optical element 46 and a transmission type holographic optical element 43 disposed at opposite sides of the light guiding plate 10 to expand a beam size.

According to example embodiments, the spatial light modulator may be a transmission type spatial light modulator accommodated in a surface of a glass plate.

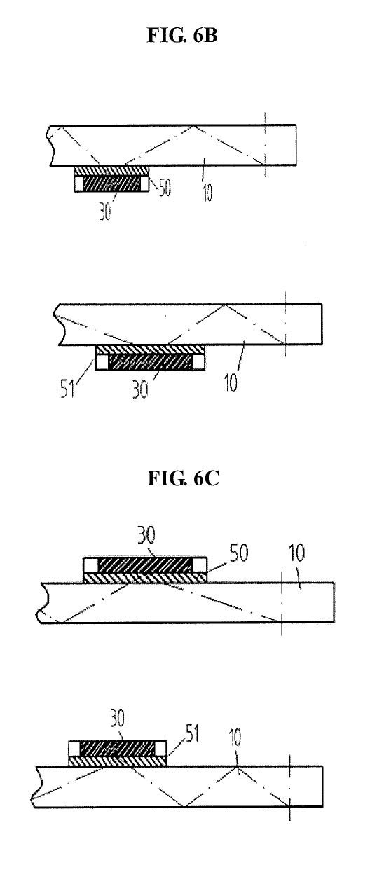

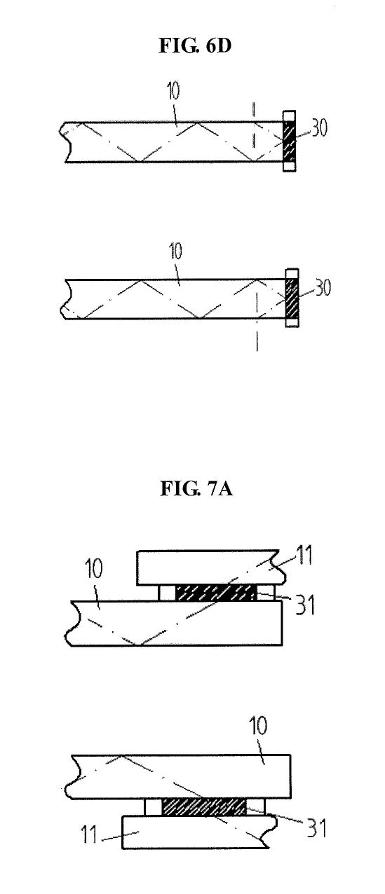

FIGS. 6A to 6D illustrate a position of a reflection type spatial light modulator on a light guiding plate, according to example embodiments.

According to example embodiments shown in FIG. 6A, a single reflection type spatial light modulator 30 may be used, being disposed at one side of a light guiding plate 10. Referring to FIGS. 6B and 6C, the spatial light modulator 30 may be mounted to a first surface or second surface of the light guiding plate 10 with respect to the observer eye according to holographic optical elements 50 and 51. According to a variant as shown in FIG. 6D the spatial light modulator 30 may be mounted to an end of the light guiding plate 10.

According to example embodiment shown in FIG. 6B, a reflection type spatial light modulator 30 may be disposed on the first surface of a light guiding plate 10 with respect to the observer eye together with a transmission type holographic optical element that changes a shape and direction of a beam after the beam is reflected by the spatial light modulator 30.

According to example embodiment shown in FIG. 6C, a reflection type spatial light modulator 30 may be disposed on the second surface of a light guiding plate 10 with respect to the observer eye together with a transmission type holographic optical element that changes a shape and direction of a wavefront after the wavefront is reflected by the spatial light modulator 30.

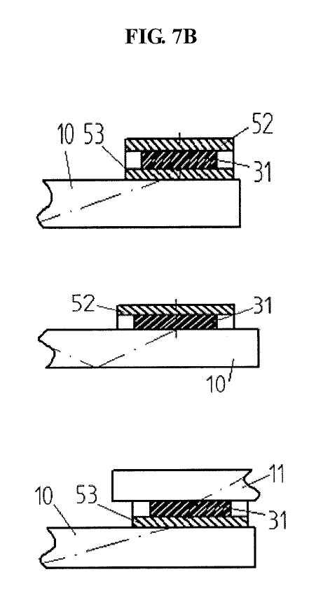

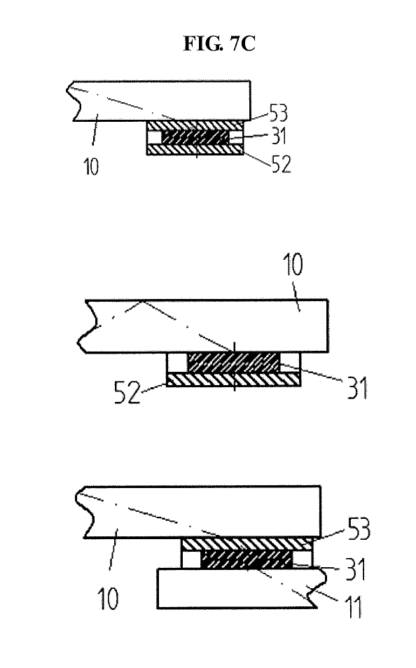

FIGS. 7A to 7C illustrate a position of a transmission type spatial light modulator on a light guiding plate, according to example embodiments.

According to example embodiment shown in FIG. 7A, a single transmission type spatial light modulator 31 may be disposed between a light guiding plate 10 and a glass plate 11 at one side of the light guiding plate 10. For example, the transmission type spatial light modulator 31 may be disposed between the light guiding plate 10 and a plane parallel plate of a second surface or first surface of the light guiding plate 10.

Referring to FIGS. 7B and 7C, a transmission type spatial light modulator 31 may be disposed on the second surface or first surface of the light guiding plate 10 together with transmission type holographic optical elements 52 and 53. According to example to embodiments, the transmission type spatial light modulator 31 may be disposed on the second surface of the light guiding plate 10 between the two transmission type holographic optical elements 52 and 53 that change a shape and direction of a beam before and after passing through the transmission type spatial light modulator 31. According to other example embodiments, the transmission type spatial light modulator 31 may be disposed on the first surface of the light guiding plate 10 between the two transmission type holographic optical elements 52 and 53 that change a shape and direction of a beam before and after passing through the transmission type spatial light modulator 31. According to yet other embodiments, the transmission type spatial light modulator 31 may be disposed on the first surface of the light guiding plate 10 between the light guiding plate 10 and a transmission type holographic optical element that changes a shape and direction of a beam before passing through the transmission type spatial light modulator 31. According to still other example embodiments, the transmission type spatial light modulator 31 may be disposed on the second surface of the light guiding plate 10 between a transmission type holographic optical element that changes a shape and direction of a beam before passing through the transmission type spatial light modulator 31.

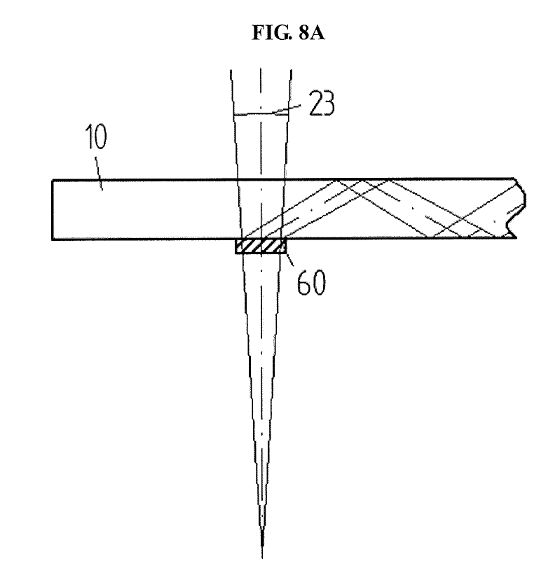

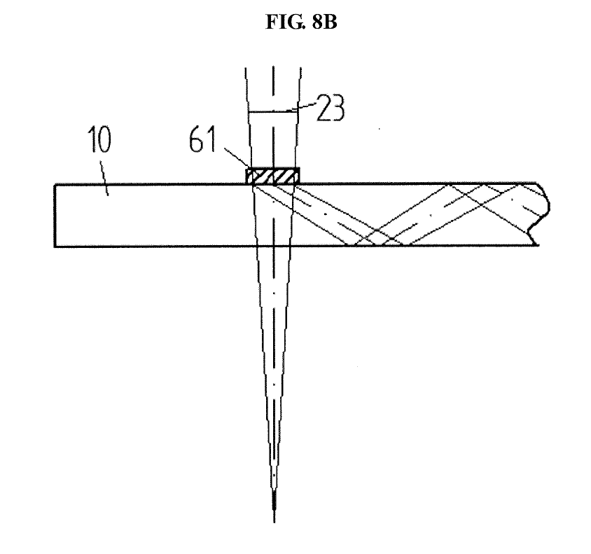

FIGS. 8A to 8B illustrate a viewing part according to a position of a holographic optical element on a light guiding plate, according to example embodiments.

According to example embodiments shown in FIG. 8A, a holographic optical element of a visual channel of a light guiding plate 10 may be disposed on a first surface of the light guiding plate 10 with respect to the observer eye, through the medium of a transmission type holographic optical element 60. In addition, at least one transmission type holographic optical element 60 may be mounted to the first surface of the light guiding plate 10 and enable output of radiation from the light guiding plate 10.

Referring to FIG. 8B, a holographic optical element of a visual channel of a light guiding plate 10 may be disposed on a second surface of the light guiding plate 10 with respect to the observer eye, through the medium of a reflection type holographic optical element 61. In addition, at least one reflection type holographic optical element 61 may be mounted to the second surface of the light guiding plate 10 and enable output of radiation from the light guiding plate 10.

The optical device according to the example embodiments may be applied to helmet mounted displays (HMD) and goggles. In addition, the optical device may be applied to a display of mobile devices, 3D glasses, holographic data display devices, and other holographic devices.

According to the example embodiments, a number of optical elements may be considerably reduced through replacement to the holographic optical element. According to other example embodiments, planar integrated optical elements may be used. According to yet other example embodiments, a rigid design of the device may be achieved. Furthermore, a planar design of the device may be achieved.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. An optical device that generates and displays a holographic dynamic and static 3-dimensional (3D) image, the optical device comprising:
a laser source of coherent radiation;
a light guiding plate;
a holographic optical element fixed to a surface of the light guiding plate;
a spatial light modulator to generate a digital hologram; and
at least one electronic unit comprising an interface unit and a control circuit for the spatial light modulator,
wherein the holographic optical element is arranged along a radiation path from the laser source such that the spatial light modulator is disposed on the light guiding plate after the holographic optical element redirects the radiation into the light guiding plate and before the holographic optical element redirects the radiation outward from the light guiding plate.

2. The optical device of claim 1, wherein the spatial light modulator performs space-time transformation of a beam along with output of a computer-generated hologram reconstructing a 3D image at output of the optical device.

3. The optical device of claim 1, wherein the holographic optical element inputs the radiation from the laser source into the light guiding plate, and transform and redirect wavefront propagation into the light guiding plate.

4. The optical device of claim 1, wherein the spatial light modulator generates a holographic image based on diffraction and interference on a modulator discrete structure that subsequently overlaps the holographic image with real objects within a field of view of the optical device.

5. The optical device of claim 1, wherein the spatial light modulator is a transmission type spatial light modulator accommodated in a surface of a glass plate.

6. The optical device of claim 5, wherein the transmission type spatial light modulator is disposed between the light guiding plate and a plane-parallel plate formed on a second surface of the light guide with respect to an observer eye.

7. The optical device of claim 5, wherein the transmission type spatial light modulator is disposed between the light guiding plate and a plane-parallel plate formed on a first surface of the light guide with respect to an observer eye.

8. The optical device of claim 5, wherein the transmission type spatial light modulator is disposed between the light guide and a plane-parallel plate formed on a first surface of the light guide with respect to an observer eye, together with a transmission type holographic optical element that changes a shape and direction of a beam after passing through the spatial light modulator.

9. The optical device of claim 5, wherein the transmission type spatial light modulator is disposed between the light guide and a plane-parallel plate formed on a second surface of the light guide with respect to an observer eye, together with a transmission type holographic optical element that changes a shape and direction of a beam after passing through the spatial light modulator.

10. The optical device of claim 5, wherein the transmission type spatial light modulator is disposed on a second surface of the light guiding plate with respect to an observer eye between two transmission type holographic optical elements that change a shape and direction of a beam before and after passing through the transmission type spatial light modulator.

11. The optical device of claim 5, wherein the transmission type spatial light modulator is disposed on a first surface of the light guiding plate with respect to an observer eye between two transmission type holographic optical elements that change a shape and direction of a beam before and after passing through the transmission type spatial light modulator.

12. The optical device of claim 5, wherein the transmission type spatial light modulator is disposed on a first surface of the light guiding plate with respect to an observer eye between the light guiding plate and a transmission type holographic optical element that changes a shape and direction of a beam before passing through the transmission type spatial light modulator.

13. The optical device of claim 5, wherein the transmission type spatial light modulator is disposed on a second surface of the light guiding plate with respect to an observer eye between the light guiding plate and a transmission type holographic optical element that changes a shape and direction of a beam before passing through the transmission type spatial light modulator.

14. The optical device of claim 1, wherein the spatial light modulator is a reflection type spatial light modulator.

15. The optical device of claim 14, wherein the reflection type spatial light modulator is disposed on a first surface of the light guiding plate with respect to an observer eye.

16. The optical device of claim 14, wherein the reflection type spatial light modulator is disposed on a second surface of the light guiding plate with respect to an observer eye.

17. The optical device of claim 14, wherein the reflection type spatial light modulator is disposed on a first surface of the light guiding plate with respect to an observer eye, together with a transmission type holographic optical element that changes a shape and direction of a beam after being reflected by the reflection type spatial light modulator.

18. The optical device of claim 14, wherein the reflection type spatial light modulator is disposed on a second surface of the light guiding plate with respect to an observer eye, together with a transmission type holographic optical element that changes a shape and direction of a wavefront after being reflected by the reflection type spatial light modulator.

19. The optical device of claim 14, wherein the reflection type spatial light modulator is disposed at an end of the light guiding plate.

20. The optical device of claim 1, wherein the holographic optical element comprises at least one reflection type holographic optical element disposed on a surface of the light guiding plate, and configured to direct the radiation into the light guiding plate, transform a beam shape, generate a wavefront ensuring uniform illumination of the spatial light modulator, and reconstruct a hologram from the spatial light modulator.
